(19) United States
(12) Patent Application Publication
(10) Pub. No.: US 2020/0144568 A1
(43) Pub. Date: May 7, 2020

(54) BATTERY MODULE, AND BATTERY PACK AND ELECTRONIC DEVICE INCLUDING THE SAME

(71) Applicant: SAMSUNG ELECTRONICS CO., LTD., Suwon-si (KR)

(72) Inventors: Junghoon LEE, Seongnam-si (KR); Seoung Jin SEO, Suwon-si (KR); Moo Ho LEE, Suwon-si (KR); Moon Il JUNG, Suwon-si (KR); Ginam KIM, Seongnam-si (KR); Sung Dug KIM, Suwon-si (KR); In KIM, Suwon-si (KR); Kyeong PANG, Suwon-si (KR); In Su LEE, Hwaseong-si (KR); Hye Jeong LEE, Suwon-si (KR); Song Won HYUN, Yongin-si (KR)

(21) Appl. No.: 16/666,614

(22) Filed: Oct. 29, 2019

(30) Foreign Application Priority Data
Nov. 7, 2018 (KR) 10-2018-0135882

(51) Int. Cl. H01M 2/10; H01M 2/26

(52) U.S. Cl. CPC H01M 2/1061; H01M 2/263

(57) ABSTRACT

A battery module and a battery pack including the same, and an electronic device. The battery module includes: a housing including a plurality of cavities and a partition wall between adjacent cavities; and an electrode assembly in a cavity of the plurality of cavities, wherein a minimum thickness t1 of the partition wall is greater than or equal to about 2 millimeters, and a ratio of the minimum thickness t1 of the partition wall relative to a maximum thickness t2 of the partition wall is about 1.3 to about 2.

### CROSS-REFERENCE TO RELATED APPLICATION

This application claims priority to and the benefit of Korean Patent Application No. 10-2018-0135882, filed in the Korean Intellectual Property Office on Nov. 7, 2018, and all the benefits accruing therefrom under 35 U.S.C. § 119, the content of which in its entirety is herein incorporated by reference.

### BACKGROUND

### 1. Field

A battery module, a battery pack including the same, and an electronic device are disclosed.

### 2. Description of the Related Art

A battery is a medium for storing electrical energy in the form of chemical energy, and is an energy storage medium that is widely used in various electronic apparatuses. Of these, rechargeable batteries have reversible charge/discharge characteristics, and include electrodes, electrolytes, and separators.

Rechargeable lithium batteries provide a high degree of freedom in article shape and are widely applied to various portable electronic devices such as notebook computers, smart phones, and smart watches. In addition, as electric vehicle markets expand, rechargeable lithium batteries may be used as power sources for electric vehicles.

For example, a rechargeable battery applied to large-sized electronic devices such as electric vehicles, industrial appliances, or the like is provided as a battery module in which a battery cell including an electrode assembly is accommodated in a housing. In this case, a housing in which the electrode assembly is accommodated may include metal.

However, when a metal housing is used, electrodes may be swollen due to gas and/or heat generated in the battery module due to repeated charging/discharging and/or internal/external impact. As a result, a central portion of the metal may be swollen (swelling phenomenon).

In addition, commercially available rechargeable batteries may not provide sufficient charge to travel a desired distance in an electric vehicle.

Therefore, there exists a need for a battery module that exhibits improved energy density to be used for, e.g., an electric automobile, while improving stability of the battery module.

### SUMMARY

An embodiment provides a battery module exhibiting desirable energy density and improved stability that may be applied to, e.g., used in, large-sized electronic devices such as electric vehicles and industrial appliances.

An embodiment provides a battery pack and an electronic device having desirable energy density and stability by including the battery module.

According to an embodiment, a battery module includes: a housing including a plurality of cavities and a partition wall between adjacent cavities; and an electrode assembly in a cavity of the plurality of cavities, wherein a minimum thickness t1 of the partition wall is greater than or equal to about 2 millimeters (mm), and a ratio of the minimum thickness t1 of the partition wall relative to a maximum thickness t2 of the partition wall is about 1.3 to about 2.

The partition wall may have a first end along a longitudinal axis of the partition wall, the longitudinal axis extending in a direction perpendicular to a direction in which the minimum thickness t1 is measured, a second end along the longitudinal axis of the partition wall, the second end being opposite the first end, and a center along the longitudinal axis of the partition wall and between the first end and the second end, a thickness of the partition wall may increase in a direction from the first end of the partition wall towards the center of the partition wall, and the thickness of the partition wall may increase in a direction from the second end of the partition wall toward the center of the partition wall.

The housing may include a sidewall portion connected to the first end of the partition wall and the second end of the partition wall, the sidewall portion may include a first sidewall directly connected to the partition wall and a second sidewall disposed parallel to a longitudinal axis of the partition wall and connected to the first sidewall, wherein the longitudinal axis extends in a direction perpendicular to a direction in which the minimum thickness t1 is measured.

The partition wall and the sidewall portion may be a single indivisible component.

An intersection of the partition wall and the first sidewall may include a rounded edge.

An intersection of the first sidewall and the second sidewall may include a rounded edge.

A minimum thickness t3 of the first sidewall may be about 2 mm to about 5 mm.

A difference between a maximum thickness t5 of a center portion of the second sidewall and a minimum thickness t4 of a side portion of the second sidewall may be about 0.3 mm to about 10 mm.

A value obtained by multiplying a maximum length (L) of a cavity of the plurality of cavities by a maximum width (W) of the cavity is defined as a reference rectangular area, and a ratio of an area of the cavity relative to the reference rectangular area may be about 0.9 to about 0.995.

Two or more cavities may be arranged along a direction perpendicular to a longitudinal axis of the partition wall, wherein the longitudinal axis extends in a direction perpendicular to a direction in which the minimum thickness t1 is measured.

First ends of the plurality of cavities may be open, and second ends of the plurality of cavities may be closed.

A portion of the plurality of cavities may each further include an electrode assembly.

Each cavity of the plurality of cavities may further include an electrode assembly.

The housing may include a liquid crystal polymer, polyethylene, polydimethylsiloxane, poly(methylmethacrylate), polycarbonate, or a combination thereof.

The housing may have an elastic modulus of about 5,000 megapascals (MPa) to about 9,000 MPa, an area variation of the plurality of cavities by swelling may be 0 to less than or equal to about 7%, and a plastic deformation of the partition wall may be 0 to less than or equal to about 0.05.

The housing has an elastic modulus of about 500 MPa to about 4,000 MPa, and an area variation of the plurality of cavities by swelling may be 0 to less than or equal to about 20%.

The housing may include a plurality of penetrating through holes in a depth direction of the plurality of cavities, wherein the depth direction is perpendicular to a direction in which a longitudinal axis of the partition wall extends and is perpendicular to a direction in which the minimum thickness t1 is measured.

The electrode assembly may include a folded electrode assembly, a stacked electrode assembly, a stack-fold electrode assembly, or a combination thereof.

According to an embodiment, a battery pack including the battery module is provided.

According to an embodiment, an electronic device including the battery pack is provided.

A battery module having desirable energy density and stability, and a battery pack and an electronic device including the battery module, may be provided.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other advantages and features of this disclosure will become more apparent by describing in further detail exemplary embodiments thereof with reference to the accompanying drawings, in which:

FIG. 1 is a perspective view of an embodiment of a battery module,

FIGS. 2 and 3 are views of embodiments showing arrangements of electrode assemblies of the battery modules,

FIG. 4 is a view showing a housing of a battery module according to an embodiment with reference to an opening, e.g., opening face, of a cavity,

FIGS. 5 to 7 show a strain derived from stresses applied to respective partition walls of which the shape viewed from the opening, e.g., opening face, is a rectangle (in FIG. 5), an ellipse (in FIG. 6), and a dumbbell (in FIG. 7),

FIG. 8 is a view an embodiment of showing stress distribution of a battery module,

FIG. 9 is a perspective view an embodiment of illustrating a modification of a housing of a battery module, and

FIGS. 10 and 11 are views of embodiments showing an electrode assembly of a battery module.

### DETAILED DESCRIPTION

Hereinafter, embodiments of the present invention will be described in detail so that those skilled in the art may easily carry out the present invention. However, the present invention may be implemented in various different forms and is not limited to the embodiments described herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a schematic structure of a battery module 10 according to an embodiment will be described.

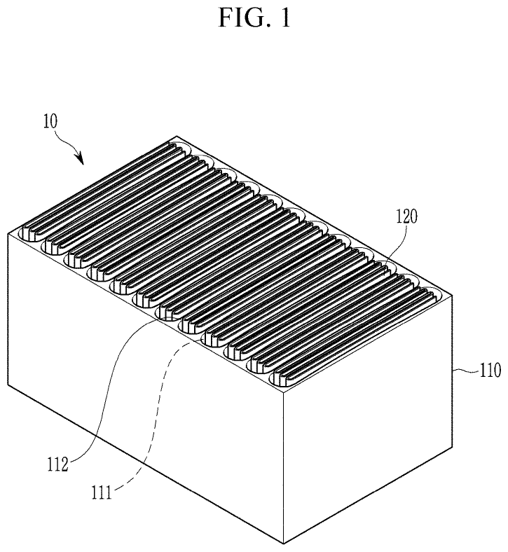

FIG. 1 is a perspective view of a battery module according to an embodiment.

Referring to FIG. 1, the battery module 10 according to an embodiment include a housing 110 including a plurality of cavities 111 and partition walls 112 partitioning, e.g., between, adjacent cavities 111, and electrode assemblies 120 housed in the cavities 111.

The battery module 10 according to an embodiment may accommodate a plurality of electrode assemblies 120 throughout, e.g., in, the housing 110. The battery module 10 according to an embodiment includes a number of electrode assemblies 120 corresponding to the cavities 111 and one electrode assembly 120 may be accommodated in one cavity 111, as shown in FIG. 1. That is, in the battery module 10 according to an embodiment, an electrode assembly 120 may be accommodated in each of the plurality of cavities 111. In this case, it may be possible to accommodate more electrode assemblies 120 compared to a battery module having the same volume, which is advantageous in terms of energy density.

However, the number, the arrangement, or a combination thereof of the electrode assemblies 120 in the battery module 10 according to an embodiment are not necessarily limited thereto.

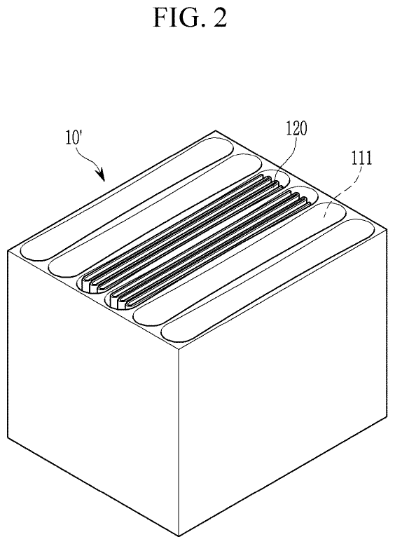

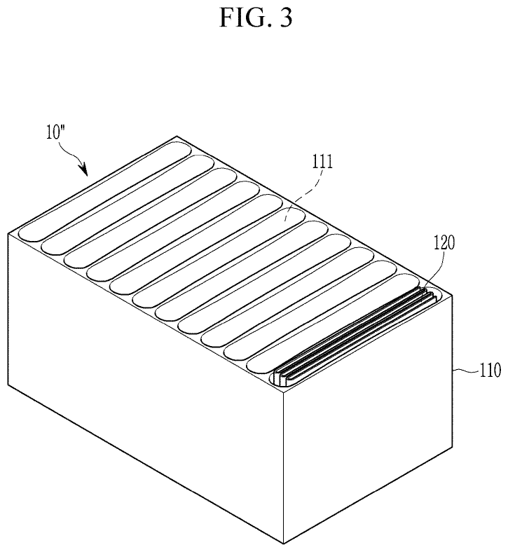

FIGS. 2 and 3 are views of embodiments showing various arrangements of electrode assemblies of the battery modules.

Referring to FIGS. 2 and 3, in the battery modules 10′ and 10″ according to embodiments, the electrode assemblies 120 may be housed only in a portion of the plurality of cavities 111. In this case, an accommodating position of the electrode assemblies 120, e.g., a portion of the plurality of cavities 111 accommodating an electrode assembly 120, may be a cavity located at a central portion of the housing 110 (see FIG. 2) or at least one cavity located at at least one end of the housing 110 (see FIG. 3).

However, when the electrode assemblies 120 are accommodated in only a portion of the cavities 111, volumes of the cavities 111, the number of the electrode assemblies 120 to be accommodated, and the like may be adjusted and volumes of the cavities 111 which do not accommodate electrode assemblies 120 relative to volumes of the cavities 111 in which the electrode assemblies 120 are accommodated may be about 10:1 to about 100:1.

Accordingly, even if swelling occurs in the cavities 111, the housing 110 may be prevented from being undesirably deformed by the cavities 111 in which the electrode assemblies 120 are not accommodated, and heat generated by charge/discharge may be more efficiently controlled.

The electrode assemblies 120 of the battery module 10 according to an embodiment may be variously arranged according to environments in which the battery module 10 is used, as well as types, materials, sizes, etc. of the housing 110 and the electrode assemblies 120, by variously setting the arrangement of the electrode assemblies 120 in this way.

In an embodiment, the electrode assemblies 120 may not be inserted into a separate casing or the like, but may be inserted directly into the cavities 111 in the battery module 10 as shown in FIGS. 1 to 3. That is, battery modules may include a plurality of battery cells including electrode assemblies inserted in housings, but in the battery module 10 according to an embodiment, the electrode assemblies 120 may be directly accommodated in the cavities 111 of the housing 110 without a casing.

Accordingly, a volume of a battery module 10 according to an embodiment may be reduced, while including a desirable number of electrode assemblies 120 in the housing 110, e.g., the battery module 10 according to an embodiment may reduce spaces equivalent to volumes of casings for accommodating the electrode assemblies, while enhancing an accommodating ratio of the electrode assemblies 120 in the housing 110. As a result, the battery module 10 according to an embodiment may have improved energy density.

In an embodiment, the housing 110 accommodates and supports the battery module 10, and also fixes a shape of the battery module 10 and the shape of the battery module 10 may be maintained to have a predetermined shape. An outer shape of the housing 110 may be variously modified depending on formation areas of the cavities 111, types of the formed cavities 111, the number of the electrode assemblies 120, and the like. For example, a cavity have a hexahedral shape in which edges are rounded.

In an embodiment, the hexahedron having the rounded edges may be rounded to have a radius of, for example, less than or equal to about 20 mm, less than or equal to about 15 mm, less than or equal to about 13 mm, and greater than or equal to about 5 mm, and for example, greater than or equal to about 10 mm. As used herein, a “rounded edge” refers to an edge having a radius of about 0.01 mm to about 10 mm, or about 0.1 mm to about 5 mm.

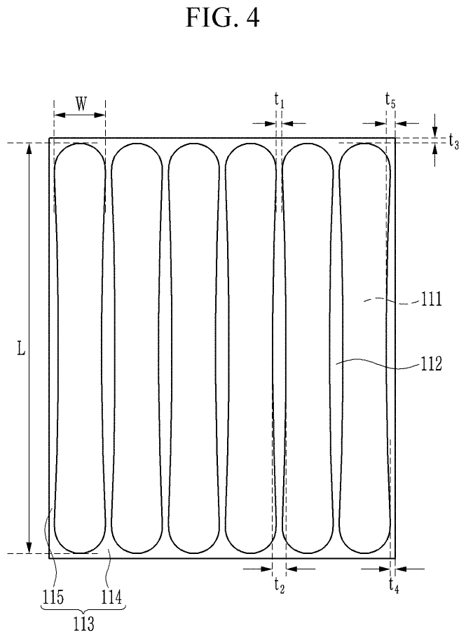

FIG. 4 is a view showing a housing of a battery module according to an embodiment with reference to an opening, e.g., opening face, of a cavity.

Referring to FIG. 4, the housing 110 of the battery module 10 according to an embodiment may have two or more cavities 111 arranged along a direction perpendicular to a long side of the partition walls 112. Accordingly, the electrode assemblies 120 may be arranged to be accommodated in at least one of the cavities 111 along a direction perpendicular to the long side of the partition walls 112 as shown in FIGS. 1 to 3.

In an embodiment, a first end of the cavities 111 may be open and a second end may be closed. In this case, the second end of the cavities 111 may stably support lower surfaces of the electrode assemblies 120 accommodated in the cavities 111. However, the embodiment is not necessarily limited thereto. For example, the first end of the cavities 111 and the second end of the cavities 111 may be open, and a flat support member that is removable from a lower surface of the housing 110 may be further disposed to support the lower surfaces of the electrode assemblies 120.

In an embodiment, the partition walls 112 may have different thicknesses depending on a position, e.g., with respect to a long side of the partition walls 112. In an embodiment, a minimum thickness of a first end of the partition walls 112 and a second end of the partition walls 112, e.g., with respect to a long side of the partition walls 112, is defined as t1, while the maximum thickness of a center portion of the partition walls 112 is defined as t2.

For example, the partition walls 112 may have a thickness that increases from the first end of the partition walls 112 toward a center portion of the partition walls 112, e.g., with respect to a long side of the partition walls 112, and from the second end of the partition walls 112 toward the center portion of the partition walls 112, e.g., with respect to a long side of the partition walls 112. That is, the partition walls 112 according to an embodiment may be formed so that t2 may be greater than t1. Because expansion of the electrode assemblies 120 may occur at the center portion, a thickness of the central portion of the partition walls 112 may be greater than the thickness of the first end of the partition walls 112 and the thickness of the second end of the partition walls 112, and so as to flexibly accommodate a stress caused by expansion of the electrode assemblies 120. Accordingly, even if the electrode assemblies 120 expand, changes in the shape of the cavities 111 viewed from the opening, e.g., an opening face, may be minimized, thereby improving the stability of the battery module 10.

In the battery module 10 according to an embodiment, the electrode assemblies 120 may be directly accommodated in the cavities 111 without a separate casing, and stress generated by expansion of the electrode assemblies 120 may be flexibly accommodated.

Accordingly, in an embodiment, the minimum thickness t1 of the first end of the partition walls and the second end of the partition walls may vary depending on elastic modulus, thermal expansion coefficient, or glass transition temperature of the material constituting the housing 110, and it is desirable that it has a thickness of at least about 2 mm or more, e.g., about 2 mm to about 10 mm. Specifically, the minimum thickness t1 of the first end of the partition walls and the second end of the partition walls may be greater than or equal to about 2 mm, for example, greater than or equal to about 3 mm, and less than or equal to about 5 mm, for example, less than or equal to about 4 mm, or for example, from about 2 mm to about 4 mm.

When the minimum thickness t1 of the first end of the partition walls and the second end of the partition walls is less than 2 mm, the partition walls may not withstand an internal stress transmitted to the partition walls 112 due to the expansion of the electrode assemblies 120. As a result, the electrode assemblies 120 may be damaged due to a plastic deformation of the partition walls 112, and as a result, stability of the battery module 10 may be decreased.

For example, a ratio (t2/t1) of the minimum thickness t1 of the first end of the partition walls and the second end of the partition walls to the maximum thickness t2 of the center portion of the partition walls, e.g., with respect to a long side of the partition walls, may be greater than about 1, for example, greater than or equal to about 1.3, or greater than or equal to about 1.4, and less than or equal to about 5, less than or equal to about 4, less than or equal to about 3, less than or equal to about 2, or less than or equal to about 1.5, and for example may be greater than about 1 and less than or equal to about 5 or about 1.3 to about 2.

When t2/t1 is less than or equal to about 1.3, a deformation of the partition walls 112 due to the expansion of the electrode assemblies 120 (hereinafter referred to as an area variation of the cavities by swelling) may be increased undesirably. When t2/t1 is greater than about 2, a volume occupied by the partition walls 112 in the housing 110 becomes undesirably large and spaces for accommodating the cavities 111 and the electrode assemblies 120 may be reduced and thus the entire energy density of the battery module 10 may be decreased.

In an embodiment, shapes of the cavities 111 viewed from the opening, e.g., opening face, may have round-shaped edges and may have a shape similar to a dumbbell having a narrowing width toward the center portion as shown in FIG. 4. In this way, when the cavities 111 having the dumbbell-like shape are formed, the stress applied to the partition walls, sidewall portions, or a combination thereof may be reduced compared with other shapes.

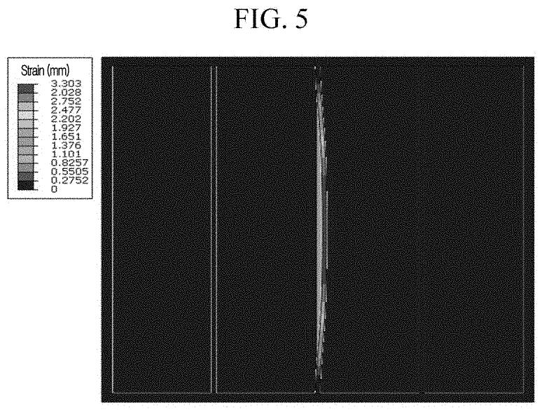

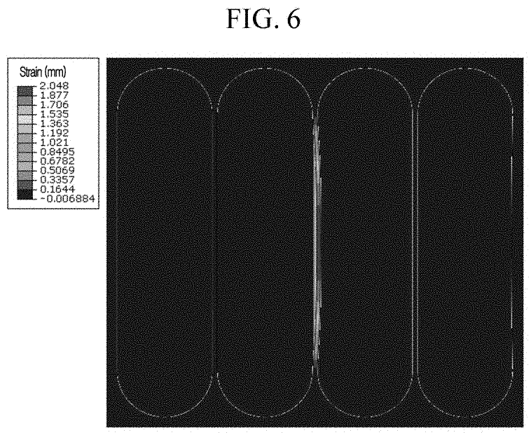

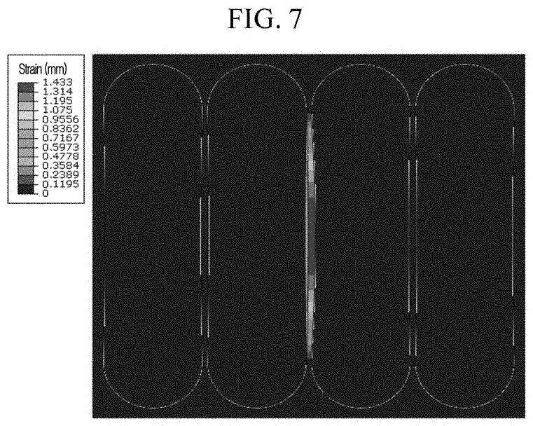

FIGS. 5 to 7 show a strain derived from stresses applied to respective partition walls of which the shape viewed from the opening, e.g., opening face, is a rectangle (in FIG. 5), an ellipse (in FIG. 6), and a dumbbell (in FIG. 7).

Referring to FIGS. 5 to 7, first, a stress applied to the partition wall due to the expansion of the electrode assemblies 120 may be concentrated at the center of the partition walls regardless of the shapes of the cavities such that the strain is derived at the center of the partition walls. However, when a shape of the opening, e.g., opening face, of the cavity is a rectangle (FIG. 5) or an ellipse (FIG. 6), the stress applied to the partition walls may be greater than that of the dumbbell shape (FIG. 7) of the cavity according to an embodiment, whereby the strain derived at the center of the partition walls of the cavity of which the shape of the surface viewed from the opening is a rectangle (FIG. 5) or an ellipse (FIG. 6) may be greater than that of the dumbbell shape (FIG. 7).

In an embodiment, the housing 110 may further include sidewall portions 113 connected to the first end of the partition walls 112 and the second end of the partition walls 112 in addition to the cavities 111 and the partition walls 112. The sidewall portions 113 are portions constituting the external circumferential surface of the housing 110. The shape of the cavities 111 viewed from the opening, e.g., opening face, may be defined by the partition walls 112 and the sidewall portions 113.

In an embodiment, the sidewall portions 113 include first sidewalls 114 directly connected to the partition walls 112 and second sidewalls 115 disposed parallel to the partition walls 112, e.g., parallel to a longitudinal axis of the partition walls 112, and directly connected to the first sidewalls 114. The first sidewalls 114 and the second sidewalls 115 may each be formed in pairs at opposite positions, e.g., intersecting one another.

In an embodiment, the partition walls 112 and the sidewall portions 113 may be integrally formed. That is, the housing 110 according to an embodiment may be an integrated structure having a plurality of cavities formed by injection molding, three-dimensional (3D) printing, or the like.

In this way, the integrated structure of the partition walls 112 and the sidewall portions 113 may contribute to improving a manufacturing process, cost, or a combination thereof since the housing 110 may be manufactured without a process of respectively forming separate constituent elements and then assembling them to form the housing 110.

The first sidewalls 114 according to an embodiment may protect the electrode assemblies 120 from an internal/external vibration/impact transferred to the electrode assemblies 120, and in addition, may have a predetermined thickness that is capable of minimizing an external shape change of the battery module 10.

In an embodiment, when a minimum thickness of the first sidewall is defined as t3, the minimum thickness t3 of the first sidewall may be desirably at least 2 mm or greater. Specifically, the minimum thickness t3 of the first sidewall may be, for example, greater than or equal to about 2 mm or greater than or equal to about 3 mm, and for example, less than or equal to about 5 mm or less than or equal to about 4 mm, and for example, from about 2 mm to about 4 mm.

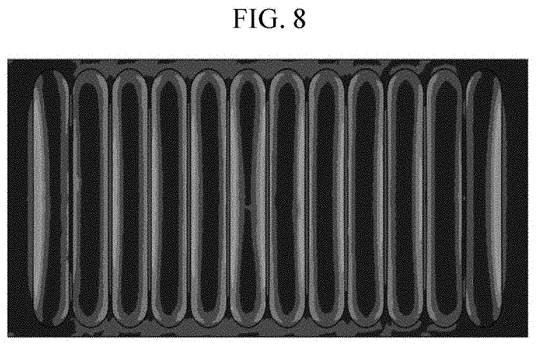

FIG. 8 is a view showing a stress distribution of a battery module according to an embodiment. In FIG. 8, the stresses are indicated in green color. As shown in FIG. 8, as the stronger the applied stress is, the brighter green color is shown. FIG. 8 shows a stress distribution when electrode assemblies are filled in all the cavities, wherein the stress applied to the two partition walls disposed at the center of a housing is measured as 7 bar, while the stress applied to the rest of the cavities is measured as 1 bar, and t2/t1 is 1.3. Herein, a von Mises stress applied to the two partition walls at the center of the cavity is 23.5 MPa.

Referring to FIG. 8, the von Mises stress due to expansion of a plurality of the electrode assemblies 120 in the housing 110 transferred to the second sidewalls 115 may equal to or greater than von Mises stress transferred to partition walls partitioning the cavity in the center of the housing. Accordingly, the second sidewalls 115 may have a different thickness, e.g., with respect to a long side thereof, and the housing 110 may elastically accept, e.g., absorb, a resultant force of the stress due to the expansion of the plurality of the electrode assemblies 120.

When a minimum thickness of a side portion or both side portions is defined as t4 and a maximum thickness of the center portion is defined as t5, e.g., with respect to a long side of the second sidewalls 115, respectively, a difference (t5−t4) between a maximum thickness t5 of the center portion of the second sidewalls 115 and a minimum thickness t4 of the second sidewall may be, for example, greater than or equal to at least about 0.3 mm, greater than or equal to about 0.4 mm, greater than or equal to about 0.5 mm, greater than or equal to about 0.6 mm, greater than or equal to about 0.8 mm, greater than or equal to about 1.0 mm, greater than or equal to about 1.2 mm, or greater than or equal to about 1.5 mm, and less than or equal to about 10 mm, less than or equal to about 9 mm, less than or equal to about 8 mm, less than or equal to about 7 mm, less than or equal to about 6 mm, less than or equal to about 5 mm, less than or equal to about 4 mm, or less than or equal to about 3 mm, and for example, about 0.3 mm to about 10 mm, about 0.3 mm to about 5 mm, or about 0.3 mm to about 3 mm.

When the difference of t5−t4 is less than about 0.3 mm, the second sidewalls 115 may not endure the resultant force of a stress due to the expansion of the plurality of the electrode assemblies 120, but when the difference of t5−t4 is greater than about 5 mm, a volume of the second sidewalls relative to that of the housing 110 is undesirably increased and thus energy density may be negatively affected.

In an embodiment, a rounded edge may be formed at an intersection of the partition walls 112 and the first sidewalls 114. Further, a rounded edge may be formed at an intersection of the first sidewalls 114 and the second sidewalls 115. Accordingly, when the cavities 111 are viewed from the opening, e.g., opening face, the cavities 111 may have a rounded edge.

In this way, when the cavities 111 are formed to have a rounded edge, the electrode assemblies 120 may be housed therein. In addition, since the housed electrode assemblies 120 have a similar edge to that of the cavities 111, the electrode assemblies 120 may be protected from an internal/external vibration/impact by minimizing a distance between the edge of the electrode assemblies 120 and the housing 110.

Further, the cavities 111 may have a size that is variously designed depending on a material, a thickness, a size, and the like of the housing 110, the partition walls 112, the sidewall portions 113, and the like. For example, when a length of one major axis of the cavities 111 is L and a maximum width thereof is W, in an embodiment, a first cavity formed in a first housing may be designed to have L1 as a length of a major axis and W1 as a maximum width thereof, a second cavity formed in a second housing may be designed to have L2 (L2≢L1) as a length of a major axis and W2 (W2≢W1) as a maximum width thereof.

However, the size of the cavities 111 according to an embodiment may be limited by a predetermined area condition thereof. Specifically, when a product of the length (L) and the maximum width (W) of the major axis is defined as a reference rectangular area, a ratio of an area of one cavity relative to the reference rectangular area is greater than or equal to about 0.9, for example, greater than or equal to about 0.91, or greater than or equal to about 0.92, and for example, less than about 1, less than or equal to about 0.995, less than or equal to about 0.99, less than or equal to about 0.989, or less than or equal to about 0.988.

The reference rectangular area is an area of a cavity having a rectangular shape, and a ratio of the area of one cavity relative to the reference rectangular area indicates a ratio of an area of one cavity 111 relative to that of a rectangular cavity according to an embodiment.

When the area ratio of one cavity relative to the reference rectangular area according to an embodiment is less than about 0.9, the cavities 111 take up, e.g., occupy, less volume in the housing 110, and thus less electrode assemblies 120 may be housed in the housing 110 or the electrode assemblies may have a smaller volume. Accordingly, energy density may be decreased compared with a housing having the same volume and an area ratio of one cavity relative to the reference rectangular area of 1.

When the area ratio of one cavity relative to the reference rectangular area is greater than about 0.995, the housing 110 may neither elastically accept, e.g., absorb, a stress due to an expansion of the electrode assemblies 120 nor satisfy the aforementioned relationship of t1 to t5, but may go through, e.g., be subject to, plastic deformation.

In addition, a material forming the housing 110 in an embodiment is not particularly limited except for excluding a metal material to secure stability of, e.g., provide stability to, the battery module 10. However, the housing 110 may be formed of a material having both rigidity and elasticity considering that the electrode assemblies 120 are housed in the cavities 111 without separate casings and that a stress due to expansion of the electrode assemblies 120 is transferred to the partition walls 112, the sidewall portions 113, or a combination thereof.

For example, the housing 110 may include a polymeric material having adequate levels of both stiffness and elasticity. The housing 110 may include, for example a liquid crystal polymer, polyethylene, e.g., high-density polyethylene, polydimethylsiloxane, poly(methylmethacrylate), polycarbonate, or a combination thereof. Specifically, the housing 110 may include a liquid crystal polymer, high-density polyethylene, or a combination thereof.

In an embodiment, the housing 110 may be made of a material having a predetermined elastic modulus range. The predetermined elastic modulus may have various ranges of, for example, greater than or equal to about 500 MPa, greater than or equal to about 600 MPa, greater than or equal to about 700 MPa, greater than or equal to about 800 MPa, greater than or equal to about 900 MPa, greater than or equal to about 1,000 MPa, or greater than or equal to about 3,000 MPa, and for example, less than or equal to about 10,000 MPa, less than or equal to about 9,000 MPa, less than or equal to about 8,000 MPa, less than or equal to about 6,000 MPa, or less than or equal to about 4,000 MPa, and for example, about 500 MPa to about 10,000 MPa or about 600 MPa to about 9,000 MPa.

In an embodiment, the housing 110 may be composed of a liquid crystal polymer. In an embodiment, the housing 110 may be an integrated structure having a plurality of cavities formed by injection molding, 3D printing, or the like of the liquid crystal polymer. In this case, the elastic modulus of the housing 110 according to an embodiment may be, for example, about 5,000 MPa to about 9,000 MPa, about 6,000 MPa to about 9,000 MPa, or about 6,000 MPa to about 8,000 MPa, and an area variation of the cavities 111 by swelling may be less than or equal to about 10%, for example, less than or equal to about 9%, less than or equal to about 8%, less than or equal to about 7%, less than or equal to about 6.8%, less than or equal to about 6%, less than or equal to about 5%, less than or equal to about 4%, less than or equal to about 3%, less than or equal to about 2%, less than or equal to about 1.5%, or less than or equal to about 1.2%. In addition, a plastic deformation, e.g., strain, of the partition walls 112 by expansion of the electrode assemblies 120 may be less than or equal to about 0.05, less than or equal to about 0.04, less than or equal to about 0.03, less than or equal to about 0.02, less than or equal to about 0.01, less than or equal to about 0.009, less than or equal to about 0.005, less than or equal to about 0.003, or even less than or equal to about 0.001.

In an embodiment, the housing 110 may be made of high-density polyethylene. In an embodiment, the housing 110 may be manufactured by forming a body by a method such as injection molding of high-density polyethylene, and then molding a plurality of cavities. Since high-density polyethylene has a low elastic modulus relative to that of the aforementioned liquid crystal polymer, when the housing 110 is formed of the high-density polyethylene, the housing may exhibit increased cavity area variation due to swelling and increased plastic deformation, e.g., strain, compared with a housing formed of the aforementioned liquid crystal polymer.

When the housing 110 is composed of high-density polyethylene, the elastic modulus of the housing 110 according to an embodiment may be, for example, about 500 MPa to about 4,000 MPa, about 600 MPa to about 4,000 MPa, about 600 MPa to about 2,000 MPa, or about 600 MPa to about 1,000 MPa, and an area variation of the cavities 111 by swelling may be less than or equal to about 20%, less than or equal to about 19%, less than or equal to about 18%, less than or equal to about 17%, less than or equal to about 16%, less than or equal to about 15%, less than or equal to about 14%, less than or equal to about 13%, or less than or equal to about 12%.

In this way, the housing 110 may exhibit an area variation of cavities 111 due to swelling and a plastic deformation, e.g., strain, of the partition walls 112 within a different range depending on a material forming the housing 110, but may exhibit desirable energy density and stability compared with a housing not satisfying a condition with respect to a shape of the cavities 111 (the condition related to the aforementioned t1 to t5), not using a metal material, or a combination thereof.

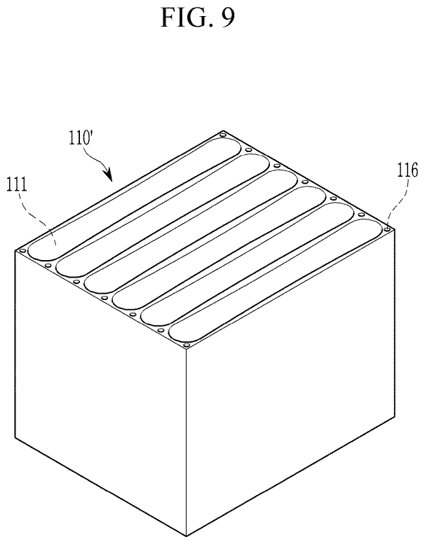

FIG. 9 is a perspective view illustrating a modification of a housing of a battery module according to an embodiment.

Referring to FIG. 9, a housing 110′ according to one modification of the embodiment may include a plurality of through-holes 116 penetrating the cavities 111 in a depth direction. Through the through-holes 116, air, cooling water, or a combination thereof may circulate through, e.g., in, the housing. Thereby, heat generated through repeated charges/discharges of the electrode assemblies 120 may be released out of the battery module 10.

The through-holes 116 may be variously designed depending on a material forming the housing 110, a kind of the electrode assemblies 120, a size of the electrode assemblies 120, an area of the cavities 111, and the like. Hollow holes having one blocked end may be disposed along with the through-holes 116, or the through-holes 116 may all be replaced with hollow holes having one blocked end.

In an embodiment, the electrode assemblies 120 include a positive electrode plate, a separator, and a negative electrode plate, wherein a positive electrode tab and a negative electrode tab are drawn out from the respective electrode plates.

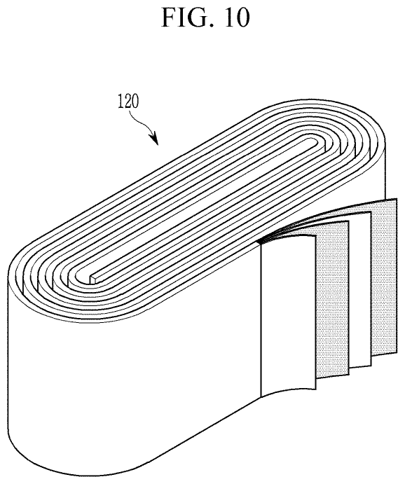

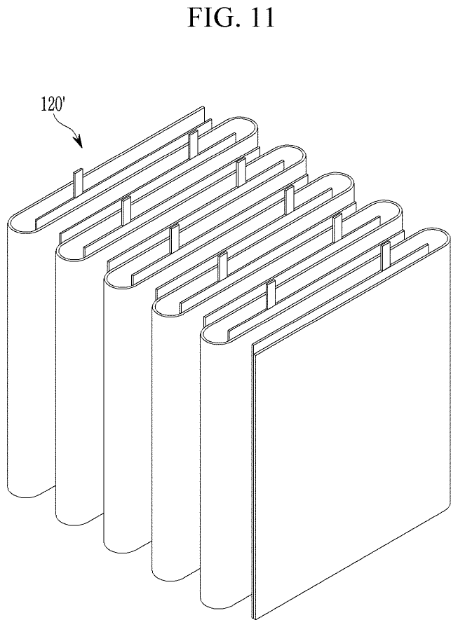

FIGS. 10 and 11 are views showing various embodiments of an electrode assembly of a battery module according to an embodiment.

The types of electrode assemblies 120 that are used in an embodiment are not particularly limited, and the electrode assemblies 120 may be, for example, a folded electrode assembly (FIGS. 10, 120), a stacked electrode assembly, a stack-fold electrode assembly (FIG. 11, 120′), or combination thereof. For example, the battery module 10 according to an embodiment may use only folded electrode assemblies 120 or only stack-fold electrode assemblies 120′.

According to an embodiment, a battery pack including the battery module 10 described above may be provided. The battery pack may include a plurality of the battery modules 10 described above.

Disposition relationships among, e.g., relative locations of, specific constituent elements of the battery pack or a plurality of the battery modules 10 have no particular limit, but a case housing a plurality of the battery modules 10, lead tabs connected to a plurality of the battery modules 10, an insulating plate finishing a top or bottom end of the open case, a Protective Circuit Module (“PCM”) and a Battery Management System (“BMS”) electrically connected to a plurality of the battery modules 10, and the like may be included.

In addition, an embodiment may provide an electronic device including the aforementioned battery pack. The electronic device has no particular limit, but may include various electronic devices using, e.g., including, the aforementioned battery pack as a main power source, an auxiliary power source, or a combination thereof. The battery pack may be applied to, e.g., used in, various fields of industry such as an electric vehicle, a hybrid vehicle, a large-sized industrial electronic device, and the like. The electronic device includes the aforementioned battery pack and thus shows desirable energy density and stability.

As described above, the battery module 10 according to an embodiment may be formed by adjusting a material forming the housing 110, the cavities 111 for the housing electrode assemblies 120 formed in the housing 110, the partition walls 112, the sidewall portions 113, or a combination thereof as aforementioned. As a result, the battery module 10 according to an embodiment may exhibit desirable energy density and stability.

Hereinafter, specific embodiments will be described. It is to be understood, however, that embodiments are not limited to the following examples, but they are for illustrative purposes only and are not intended to be limiting.

### EXAMPLES 1 TO 16 AND COMPARATIVE EXAMPLES 1 TO 8

43 grams (g) of hydroxybenzoic acid (“HBA”), 38.79 g of isophthalic acid (“IPA”), 14.49 g of biphenol (“BP”), 17.14 g of hydroquinone (“HQ”), and 95.35 g of acetic anhydride are put in a 200 milliliter (mL)-glass reactor equipped with a torque meter, a thermometer, and a reflux condenser to assemble the reactor, and then heated up to 140° C. while stirring at 150 revolutions per minute (rpm) for 30 minutes and maintained at 140° C. for 1 hour. Subsequently, after replacing the reflux condenser with a Dean-Stark condenser, the reactor is slowly heated up to 330° C. over 2 hours. When the temperature reaches 330° C., the pressure of the reactor is slowly reduced to 10 Torr over 30 minutes, and then, when agitation torque becomes 0.4 A after the pressure reaches 10 Torr, the reaction is stopped to collect a liquid crystal polymer, a polymerization product. The polymer is compounded by adding various additives to compensate several properties such as moisture permeation suppression and the like, and then injection-molded at 300 to 350° C. to manufacture a housing having twelve cavities. As for the additives, CaO (#600H) of Hwasung Chemical Co., and/or graphite (C-therm011) of Imerys Co., and/or a small amount of antioxidant may be used.

Subsequently, an electrode assembly (a stacked electrode assembly, SDI, Inc.) is housed in each cavity to respectively manufacture battery modules according to Examples 1 to 16 and Comparative Examples 1 to 8.

Each constituent element in the battery modules according to Examples 1 to 16 and Comparative Examples 1 to 8 is shown in Table 1, and the cavities are rounded to have a radius of 12.5 millimeters (mm).

TABLE 1

| | | | | | | Cavity | | |
|---|---|---|---|---|---|---|---|---|
| | | | | | | | | Area/ |
| | | | | Sidewall | | Reference | Area | reference |
| | Partition Wall | | | portion | | rectangular | (square | rectangular |
| | t1 | t2 | | t3 | t5-t4 | area | millimeters | area × 100% |
| | (mm) | (mm) | t2/t1 | (mm) | (mm) | (L × W) | (mm²)) | (%) |
| Example 1 | 2 | 2.6 | 1.3 | 2 | 0.3 | 400 × 25 | 9716 | 98.5 |
| Example 2 | 2 | 3 | 1.5 | 2 | 0.5 | 400 × 25 | 9616 | 97.5 |
| Example 3 | 2 | 3.6 | 1.8 | 2 | 0.8 | 400 × 25 | 9466 | 95.9 |
| Example 4 | 2 | 4 | 2 | 2 | 1 | 400 × 25 | 9366 | 94.9 |
| Example 5 | 3 | 3.9 | 1.3 | 3 | 0.45 | 400 × 25 | 9641 | 97.7 |
| Example 6 | 3 | 4.5 | 1.5 | 3 | 0.75 | 400 × 25 | 9491 | 96.2 |
| Example 7 | 3 | 5.4 | 1.8 | 3 | 1.2 | 400 × 25 | 9266 | 93.9 |
| Example 8 | 3 | 6 | 2 | 3 | 1.5 | 400 × 25 | 9116 | 92.4 |
| Example 9 | 3 | 3.9 | 1.3 | 3 | 0.45 | 300 × 25 | 7221 | 98.0 |
| Example 10 | 3 | 4.5 | 1.5 | 3 | 0.75 | 300 × 25 | 7091 | 96.3 |
| Example 11 | 3 | 5.4 | 1.8 | 3 | 1.2 | 300 × 25 | 6926 | 94.0 |
| Example 12 | 3 | 6 | 2 | 3 | 1.5 | 300 × 25 | 6816 | 92.5 |
| Example 13 | 3 | 3.9 | 1.3 | 3 | 0.45 | 200 × 25 | 4761 | 97.8 |
| Example 14 | 3 | 4.5 | 1.5 | 3 | 0.75 | 200 × 25 | 4691 | 96.4 |
| Example 15 | 3 | 5.4 | 1.8 | 3 | 1.2 | 200 × 25 | 4586 | 94.2 |
| Example 16 | 3 | 6 | 2 | 3 | 1.5 | 200 × 25 | 4516 | 92.8 |
| Comparative | 1 | 1.3 | 1.3 | 1 | 0.15 | 400 × 25 | 9791 | 99.2 |
| Example 1 | | | | | | | | |
| Comparative | 1 | 1.5 | 1.5 | 1 | 0.25 | 400 × 25 | 9741 | 98.7 |
| Example 2 | | | | | | | | |
| Comparative | 1 | 1.8 | 1.8 | 1 | 0.4 | 400 × 25 | 9666 | 98.0 |
| Example 3 | | | | | | | | |
| Comparative | 1 | 2 | 2 | 1 | 0.5 | 400 × 25 | 9616 | 97.5 |
| Example 4 | | | | | | | | |
| Comparative | 1 | 1.8 | 1.8 | 1 | 0.4 | 300 × 25 | 7219 | 98.0 |
| Example 5 | | | | | | | | |
| Comparative | 1 | 2 | 2 | 1 | 0.5 | 300 × 25 | 7182 | 97.5 |
| Example 6 | | | | | | | | |
| Comparative | 1 | 1.8 | 1.8 | 1 | 0.4 | 200 × 25 | 4772 | 98.1 |
| Example 7 | | | | | | | | |
| Comparative | 1 | 2 | 2 | 1 | 0.5 | 200 × 25 | 4749 | 97.6 |
| Example 8 | | | | | | | | |

The battery modules according to Examples 1 to 16 and Comparative Examples 1 to 8 are measured regarding, e.g., for, a stress applied to a center portion of a partition wall contacting an inserted electrode assembly, a displacement of the partition wall due to swelling, an area variation of the cavities due to the swelling, and a plastic deformation of the center portion of the partition wall calculated through finite element modeling, the results of which are respectively shown in Table 2.

When each property shown in Table 2 is obtained, the battery modules undergo the following changes. Specifically, surface contact of the center portion of the partition wall and the electrode assembly increases during swelling, and an area of the cavities is decreased as the swelling increases.

TABLE 2

| | Stress applied | | Area | |
|---|---|---|---|---|
| | to a center | Displacement | Variation | Plastic |
| | portion of | of partition | of cavity | deformation |
| | partition wall | wall by | by | of partition |
| | (megapascals | swelling | swelling | wall center |
| | (MPa)) | (mm) | (%) | portion |
| Example 1 | 62.4 | 1.70 | 6.8 | 0.0415 |
| Example 2 | 56 | 1.40 | 5.6 | 0.0307 |
| Example 3 | 57.1 | 1.10 | 4.4 | 0.0229 |
| Example 4 | 56.7 | 1.00 | 4.0 | 0.0173 |
| Example 5 | 53.3 | 0.70 | 2.8 | 0.0134 |
| Example 6 | 45.3 | 0.60 | 2.4 | 0.009 |
| Example 7 | 41.9 | 0.50 | 2.0 | 0.003 |
| Example 8 | 39.8 | 0.4 | 1.6 | 0 |
| Example 9 | 44.1 | 0.6 | 2.4 | 0.0125 |
| Example 10 | 34.4 | 0.5 | 2.0 | 0.0069 |
| Example 11 | 32.3 | 0.4 | 1.6 | 0.0006 |
| Example 12 | 31 | 0.3 | 1.2 | 0 |
| Example 13 | 31 | 0.6 | 2.4 | 0.0097 |
| Example 14 | 25.7 | 0.50 | 2.0 | 0.0035 |
| Example 15 | 19.3 | 0.3 | 1.2 | 0 |
| Example 16 | 18.2 | 0.3 | 1.2 | 0 |
| Comparative | 163.5 | 8.1 | 32.4 | 0.1001 |
| Example 1 | | | | |
| Comparative | 149.9 | 6.6 | 26.4 | 0.1071 |
| Example 2 | | | | |
| Comparative | 122.2 | 4.8 | 19.2 | 0.0883 |
| Example 3 | | | | |
| Comparative | 107.9 | 3.9 | 15.6 | 0.0650 |
| Example 4 | | | | |
| Comparative | 103.5 | 4.6 | 18.4 | 0.0711 |
| Example 5 | | | | |
| Comparative | 93.3 | 3.8 | 15.2 | 0.0587 |
| Example 6 | | | | |
| Comparative | 109.1 | 3.6 | 14.4 | 0.0450 |
| Example 7 | | | | |
| Comparative | 76.6 | 3.2 | 12.8 | 0.0381 |
| Example 8 | | | | |

(In Table 2, a modulus of a housing is 7,778 MPa due to an elastic modulus of a liquid crystal polymer.)

Referring to Tables 1 and 2 together, when t1 is 1 mm, an area variation of cavities is greater than when t1 is 2 mm or greater, and accordingly, a plastic deformation of the partition wall in the center portion is also greater.

An area ratio of cavities (an area per cavity/a reference rectangular area) is changed depending on a change of a major axis length L of the cavity, and accordingly, even though the partition wall and a sidewall portion share the same specifications, displacement of the partition wall due to a stress applied to a center portion of the partition wall and thereby swelling, an area variation of cavities due to the swelling and a plastic deformation may be changed.

Referring to the results of Tables 1 and 2, a battery module according to exemplary embodiments satisfies the above specifications and thus may simultaneously satisfy an area variation of less than or equal to 7% of cavities due to the swelling and a plastic deformation of less than or equal to 0.05. In addition, Examples 1 to 16 each having a relatively high elastic modulus may provide a battery module having a thickness of t1 of about 1.3 mm.

### EXAMPLES 17 TO 28 AND COMPARATIVE EXAMPLES 9 TO 16

Battery modules according to Examples 17 to 28 and Comparative Examples 9 to 16 are manufactured according to the same method as Examples 1 to 16 and Comparative Examples 1 to 8 by adding various additives for compensating several properties such as moisture permeation suppression and the like (the additives may be selected from an additive group shown in Examples 1 to 16) to a high-density polyethylene resin (B230A, Hanwha Total Petrochemical Co., Ltd.), and then injection-molding the mixture at 200 to 300° C. to manufacture a housing having twelve cavities.

The various specifications of the battery modules according to Examples 17 to 28 and Comparative Examples 9 to 16 are the same as those of Examples 5 to 16 and Comparative Examples 1 to 8, so the detailed descriptions thereof will be omitted.

Regarding the battery modules according to Examples 17 to 28 and Comparative Examples 9 to 16, a stress applied to a center portion of a partition wall contacting an electrode assembly inserted therein, a displacement of the partition wall due to the swelling, and an area variation of cavities due to the swelling are respectively shown in Table 3.

TABLE 3

| | Stress applied to a | Displacement | Area Variation |
|---|---|---|---|
| | center portion of | of partition wall | of cavity by |
| | partition wall | by swelling | swelling |
| | (MPa) | (mm) | (%) |
| Example 17 | 41.10 | 4.80 | 19.2 |
| Example 18 | 37.20 | 4.30 | 17.2 |
| Example 19 | 36.70 | 3.80 | 15.2 |
| Example 20 | 36.00 | 3.50 | 14.0 |
| Example 21 | 30.10 | 4.70 | 18.8 |
| Example 22 | 26.10 | 4.10 | 16.4 |
| Example 23 | 27.30 | 3.50 | 14.0 |
| Example 24 | 27.40 | 3.20 | 12.8 |
| Example 25 | 24.10 | 4.50 | 18.0 |
| Example 26 | 21.70 | 4.00 | 16.0 |
| Example 27 | 18.50 | 3.20 | 12.8 |
| Example 28 | 18.60 | 2.90 | 11.6 |
| Comparative | 41.40 | 17.5 | 70.0 |
| Example 9 | | | |
| Comparative | 51.80 | 16.8 | 67.2 |
| Example 10 | | | |
| Comparative | 46.60 | 15.6 | 62.4 |
| Example 11 | | | |
| Comparative | 44.60 | 14.6 | 58.4 |
| Example 12 | | | |
| Comparative | 83.90 | 14.4 | 57.6 |
| Example 13 | | | |
| Comparative | 44.10 | 13.6 | 54.4 |
| Example 14 | | | |
| Comparative | 47.40 | 10.8 | 43.2 |
| Example 15 | | | |
| Comparative | 41.70 | 10.3 | 41.2 |
| Example 16 | | | |

(In Table 3, a modulus of a housing is 692 MPa due to an elastic modulus of high-density polyethylene.)

Referring to Tables 1 and 3 together, a reference regarding, e.g., of, an elastic modulus due to a material itself when the material of a housing is changed, a cavity area variation due to swelling, and a plastic deformation may be changed, but the battery modules according to Examples 17 to 28 exhibit less displacement of the partition wall due to swelling, less cavity area variation due to the swelling, and less plastic deformation than the battery modules according to Comparative Examples 9 to 16. In addition, Examples 17 to 28, each having a relatively lower elastic modulus, exhibit that a thickness of t1 may be formed to be about 2 mm.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery module comprising:
a housing comprising a plurality of cavities and a partition wall between adjacent cavities; and
an electrode assembly in a cavity of the plurality of cavities,
wherein a minimum thickness t1 of the partition wall is greater than or equal to about 2 millimeters, and
a ratio of the minimum thickness t1 of the partition wall to a maximum thickness t2 of the partition wall is about 1.3 to about 2.

2. The battery module of claim 1, wherein
the partition wall has
a first end along a longitudinal axis of the partition wall, the longitudinal axis extending in a direction perpendicular to a direction in which the minimum thickness t1 is measured,
a second end along the longitudinal axis of the partition wall, the second end being opposite the first end, and
a center along the longitudinal axis of the partition wall and between the first end and the second end,
wherein a thickness of the partition wall increases in a direction from the first end of the partition wall towards the center of the partition wall, and
wherein the thickness of the partition wall increases in a direction from the second end of the partition wall toward the center of the partition wall.

3. The battery module of claim 1, wherein the housing comprises a sidewall portion connected to the first end of the partition wall and the second end of the partition wall,
wherein the sidewall portion comprises
a first sidewall directly connected to the partition wall and
a second sidewall disposed parallel to a longitudinal axis of the partition wall and connected to the first sidewall, and
wherein the longitudinal axis extends in a direction perpendicular to a direction in which the minimum thickness t1 is measured.

4. The battery module of claim 3, wherein the partition wall and the sidewall portion are a single indivisible component.

5. The battery module of claim 3, an intersection of the partition wall and the first sidewall comprises a rounded edge.

6. The battery module of claim 3, wherein an intersection of the first sidewall and the second sidewall comprises a rounded edge.

7. The battery module of claim 3, wherein a minimum thickness t3 of the first sidewall is about 2 millimeters to about 5 millimeters.

8. The battery module of claim 3, wherein a difference between a maximum thickness t5 of a center portion of the second sidewall and a minimum thickness t4 of a side portion of the second sidewall is about 0.3 millimeters to about 10 millimeters.

9. The battery module of claim 1, wherein a value obtained by multiplying a maximum length of a cavity of the plurality of cavities by a maximum width of the cavity is defined as a reference rectangular area, and
wherein a ratio of an area of the cavity relative to the reference rectangular area is about 0.9 to about 0.995.

10. The battery module of claim 1, wherein two or more cavities are arranged along a direction perpendicular to a longitudinal axis of the partition wall, and wherein the longitudinal axis extends in a direction perpendicular to a direction in which the minimum thickness t1 is measured.

11. The battery module of claim 1, wherein first ends of the plurality of cavities is open, and second ends of the plurality of cavities is closed.

12. The battery module of claim 1, wherein a portion of the plurality of cavities each further comprise an electrode assembly.

13. The battery module of claim 1, wherein each cavity of the plurality of cavities further comprises an electrode assembly.

14. The battery module of claim 1, wherein the housing comprises a liquid crystal polymer, polyethylene, polydimethylsiloxane, poly(methylmethacrylate), polycarbonate, or a combination thereof.

15. The battery module of claim 1, wherein the housing has an elastic modulus of about 5,000 megapascals to about 9,000 megapascals,
an area variation of the plurality of cavities by swelling is 0 to less than or equal to about 7%, and
a plastic deformation of the partition wall is 0 to less than or equal to about 0.05.

16. The battery module of claim 1, wherein the housing has an elastic modulus of about 500 megapascals to about 4,000 megapascals, and
an area variation of the plurality of cavities by swelling is 0 to less than or equal to about 20%.

17. The battery module of claim 1, wherein the housing comprises a plurality of penetrating through holes in a depth direction of the plurality of cavities, wherein the depth direction is perpendicular to a direction in which a longitudinal axis of the partition wall extends and is perpendicular to a direction in which the minimum thickness t1 is measured.

18. The battery module of claim 1, wherein the electrode assembly comprises a folded electrode assembly, a stacked electrode assembly, a stack-fold electrode assembly, or a combination thereof.

19. A battery pack comprising the battery module of claim 1.

20. An electronic device comprising the battery pack of claim 19.
